(19) United States
(12) Patent Application Publication
(10) Pub. No.: US 2006/0152880 A1
(43) Pub. Date: Jul. 13, 2006

(54) Apparatus for use by a person for dissipating an electrostatic charge

(76) Inventor: David Michael Lander, Enfield (GB)

Correspondence Address: Iandiorio & Teska, 260 Bear Hill Road, Waltham, MA, 02451-1018, US

(21) Appl. No.: 10/542,583

(22) PCT Filed: Jan. 19, 2004
(86) PCT No.: PCT/GB04/00215

§ 371 Date: Jul. 19, 2005

(30) Foreign Application Priority Data
Jan. 22, 2003 (GB) 0301468.5

(51) Int. Cl. H05F 3/00

(52) U.S. Cl. 361/220

(57) ABSTRACT

Apparatus (2) for use by a person for dissipating an electrostatic charge, comprising a body portion (4) made of an electrically conducting material for being held in the person's hand, a contact portion (6) made of an electrically conducting material for contacting an object (8) in order to dissipate the electrostatic charge, and an intermediate portion (10) made of an electrically conducting material positioned between the body portion (4) and the contact portion (6). A resistor (24) is mounted on the intermediate portion (10), a first leaf spring (28) is mounted on the first part (16) of the intermediate portion (10) such that the first leaf spring (28) causes electrical contact between a first lead (30) from the resistor (24) and the interior (32) of the body portion (4), and a second leaf spring (34) is mounted in the recess (14) in the contact portion (6) such that the second leaf spring (34) causes electrical contact between a second lead (36) from the resistor (24) and the interior (38) of the contact portion (6). The compression of the second leaf spring (34) provides both secure electrical contact and a constant upward force thereby preventing the loosening of the pair of screws (22) located between the intermediate portion (10) and the contact portion (6).

This invention relates to apparatus for use by a person for dissipating an electrostatic charge.

It is well known that persons can receive painful or discomforting shocks caused by static electricity. The static electricity may be in the form of an electrostatic charge on a person or on an object. When the person and the object get close together or touch, there occurs an electrostatic discharge, with the result that a person often receives a painful or discomforting shock.

Protection against electrostatic discharge is well known in the electronics industry where there are extensive ranges of equipment available for the protection of electronic components and assemblies throughout manufacturing processes. Apparatus is also known outside of the electronics industry for providing protection against electrostatic discharge. Thus, for example, anti-static strips are available for motor vehicles which hang from the vehicles and touch the road surface with a view to dissipating the build up of electrostatic charge on the bodywork of the vehicles, typically caused by friction between the vehicle tyres and the road surface.

Also known is apparatus for use by a person for dissipating an electrostatic charge, the apparatus being in the form of a key holder. There are several known designs of such apparatus and a person uses the apparatus to touch a contact surface such for example as a metal door handle or a metal filing cabinet. These known different designs of apparatus are such that their manufacture is often impractical from one or more of the aspects of cost effective production, aesthetically pleasing design, and ability to continue functioning under conditions of robust use.

It is an aim of the present invention to reduce the above mentioned problems.

Accordingly, in one non-limiting embodiment of the present invention there is provided apparatus for use by a person for dissipating an electrostatic charge, which apparatus comprises a body portion for being held in the person's hand, a contact portion for contacting an object in order to dissipate the electrostatic charge, and an intermediate portion positioned between the body portion and the contact portion, and the apparatus being such that the body portion is made of an electrically conducting material, the contact portion is made of an electrically conducting material, the intermediate portion is made of an electrically insulating material, the body portion has a recess, the contact portion has a recess, the intermediate portion has a first part which extends into the recess in the body portion and which is secured to the body portion by first securing means, the intermediate portion has a second part which extends into the recess in the contact portion and which is secured to the contact portion by second securing means, a resistor is mounted on the intermediate portion, a first leaf spring is mounted on the first part of the intermediate portion such that the first leaf spring causes electrical contact between a first lead from the resistor and the interior of the body portion, and a second leaf spring is mounted in the recess in the contact portion such that the second leaf spring causes electrical contact between a second lead from the resistor and the interior of the contact portion, whereby the first securing means is a single screw located in a bore extending from an end of the body portion remote from the contact portion and the second securing means is a pair of screws extending through the second part of the intermediate portion and into the contact portion such that the compression of the second leaf spring provides both secure electrical contact and a constant upward force thereby preventing the loosening of the pair of screws located between the intermediate portion and the contact portion.

The apparatus of the present invention is able to be manufactured in a cost effective manner because the body portion, the contact portion and the intermediate portion are arranged easily to fit together. This in turn enables the various parts of the apparatus to be produced in a manner which enables the apparatus to function well under conditions of robust use, and also enables the apparatus to be produced in aesthetically pleasing designs. The second leaf spring acts as a shake proof washer for the pair of screws of the second securing means.

The apparatus may be one in which the pair of screws may extend one each through a pair of wing members on the second part of the intermediate portion.

The apparatus may be one in which the body portion includes attachment means for attaching a key holder to the body portion. In this case, the apparatus can be carried by the person with their keys and the apparatus is then usually always ready for use. If desired however the apparatus of the present invention can be used on its own and without attachment to another object such for example as a key holder. In this case, then the apparatus is simply carried for use when it is necessary to dissipate an electrostatic charge either from the person carrying the apparatus, or from an object about to be touched by the person.

When the body portion includes the attachment means for attaching the key holder, then the attachment means is preferably a hole through which the key holder is passed. Alternative attachment means may however be employed so that, for example, the attachment means may be a screw-threaded portion for receiving a screw-threaded cap.

The apparatus of the present invention may be manufactured and sold with or without the key holder. Preferably the key holder is a key ring but other types of key holder may be employed.

Any suitable and appropriate electrically conducting material may be employed for the body portion. Thus, for example, the body portion may be made of a metal alloy. The metal alloy may be finished with matt nickel. Other finishes may be employed.

Any suitable and appropriate electrically conducting material may be employed for the contact portion. Thus, for example, the contact portion may be made of a metal alloy. The metal alloy may be finished with shiny nickel. Other finishes may be employed.

The apparatus may be one in which the contact portion has a covering of an electrically conducting material. The covering may be in the form of a coating. The covering may be of an electrically conductive rubber or an electrically conductive plastics material. The covering can be a non-scratch covering and it can be soft. The covering may be such as to ensure that objects contacted by the contact portion are not damaged, for example scratched.

Any suitable and appropriate electrically insulating material may be employed for the intermediate portion. Preferably, the intermediate portion is made of acrylonitrile butadiene styrene (ABS). The intermediate portion may be provided with a covering of an electrically insulating material. The covering may be in the form of a coating. The electrically insulating material may be rubber or a plastics material. The covering may be designed to give an aesthetically pleasing look to the intermediate portion and/or a soft pleasing touch to the intermediate portion. Still further, the covering may be employed to provide a water-proof connection between the intermediate portion and the body portion, and between the intermediate portion and the contact portion.

Preferably, the apparatus is produced to be generally tubular in shape. Altemative shapes may however be produced so that, for example, the apparatus may be in the form of a sphere.

Embodiments of the invention will now be described solely by way of example and with reference to the accompanying drawings in which:

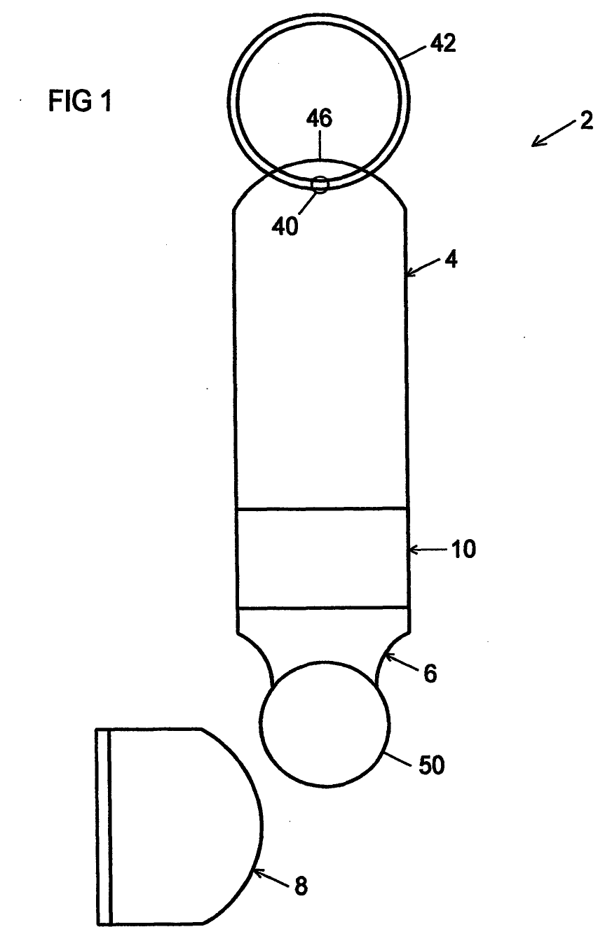

FIG. 1 shows first apparatus for use by a person for dissipating an electrostatic charge, the apparatus being shown in use;

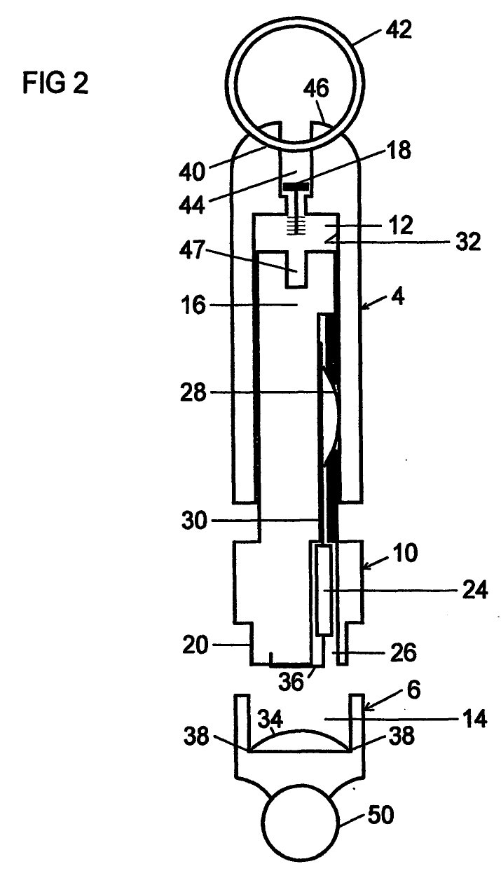

FIG. 2 is an exploded sectional view through the apparatus shown in FIG. 1;

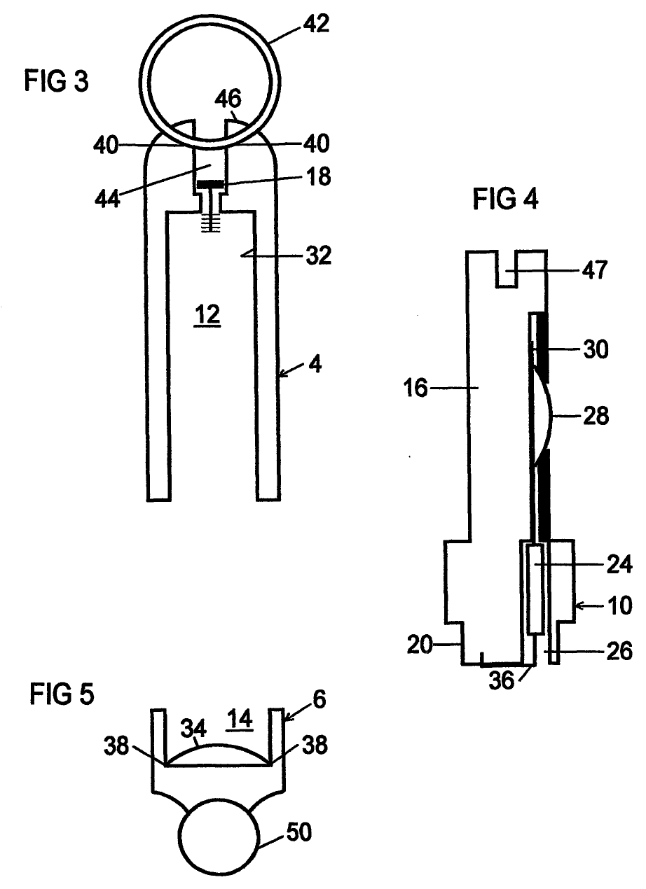

FIG. 3 shows a body portion forming part of the apparatus shown in FIG. 1;

FIG. 4 shows an intermediate portion forming part of the apparatus shown in FIG. 1;

FIG. 5 shows a contact portion forming part of the apparatus shown in FIG. 1;

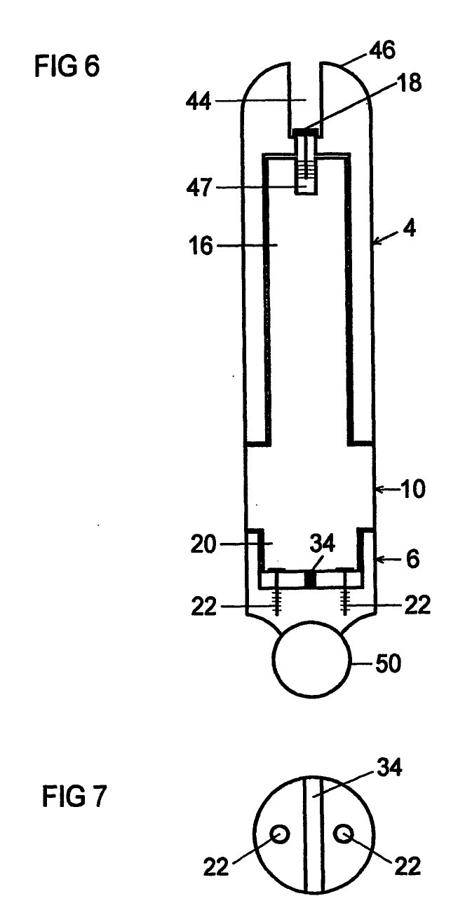

FIG. 6 illustrates how the body portion shown in FIG. 3, the intermediate portion shown in FIG. 4 and the contact portion shown in FIG. 5 are connected together;

FIG. 7 is a top view of the contact portion shown in FIG. 5 and illustrates the placing of second securing means in the form of screws with respect to a second leaf spring; and

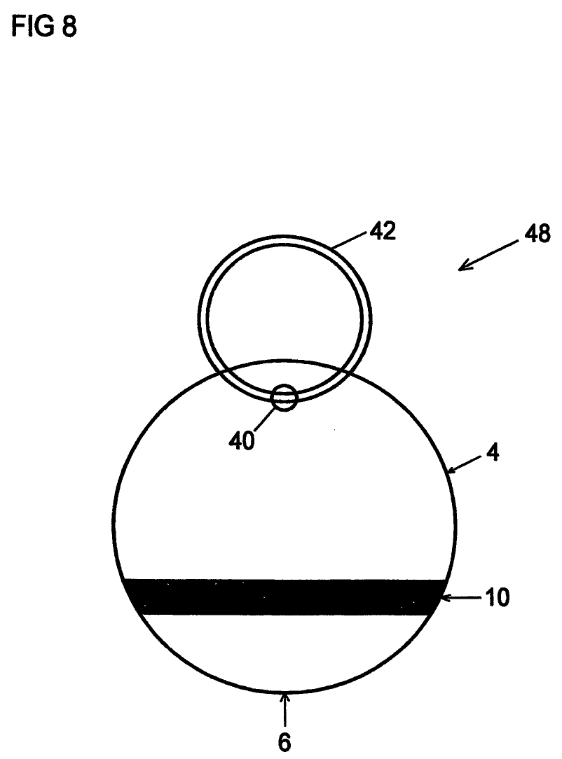

FIG. 8 shows second apparatus for use by a person for dissipating an electrostatic charge.

Referring to FIGS. 1-7, there is shown apparatus 2 for use by a person for dissipating an electrostatic charge. The apparatus 2 comprises a body portion 4 for being held in the person's hand, and a contact portion 6 for contacting an object 8 in order to dissipate the electrostatic charge. The apparatus 2 also comprises an intermediate portion 10 positioned between the body portion 4 and the contact portion 6.

The apparatus 2 is such that the body portion 4 is made of an electrically conducting material. The contact portion 6 is made of an electrically conducting material. The intermediate portion 10 is made of an electrically insulating material.

The body portion 4 has a recess 12. The contact portion 6 has a recess 14. The intermediate portion 10 has a first part 16 which extends into the recess 12 in the body portion 4 and which is secured to the body portion 4 by first securing means 18. The intermediate portion 10 has a second part 20 which extends into the recess 14 in the contact portion 6 and which is secured to the contact portion 6 by second securing means 22.

The apparatus 2 is such that a resistor 24 is mounted on the intermediate portion 10. More specifically, the resistor 24 is mounted in a bore 26 in the intermediate portion 10.

A first leaf spring 28 is mounted on the first part 16 of the intermediate portion 10 such that the first leaf spring 28 causes electrical contact between a first lead 30 from the resistor 24 and the interior 32 of the body portion 4. A second leaf spring 34 is mounted in the recess 14 in the contact portion 6 such that the second leaf spring 34 causes electrical contact between a second lead 36 from the resistor 24 and the interior 38 of the contact portion 6.

The body portion 4 includes attachment means 40 for attaching a key holder in the form of a key ring 42 to the body portion 4. As can be seen from the drawings, the attachment means 40 is in the form of a hole through which the key ring 42 is passed.

The first securing means 18 is a single screw 18 as shown which is provided in a bore 44 in the body portion 4. The bore 44 extends from an end 46 of the body portion 4 remote from the contact portion 6. The screw 18 screws into a bore 47 in the first part 16.

The second securing means 22 is a pair of screws 22 which are best seen from FIGS. 6 and 7. The pair of screws 22 extend through the second part 20 of the intermediate portion 10 and into the contact portion 6. The pair of screws 22 extend one each through a pair of wing members on the second part 20 of the intermediate portion 10. The pair of screws 22 are positioned one on either side of the second leaf spring 34.

The body portion 4 is made of a metal alloy which is provided with a matt nickel finish. Other metals and other finishes may be employed as desired. The contact portion 6 is made of a metal alloy with a shiny nickel finish. Again other metals and finishes may be employed. The intermediate portion 10 is made of ABS but again other materials may be employed.

The apparatus 2 is generally tubular in shape and it has an aesthetically pleasing appearance. The various parts are able to be connected together such that the apparatus 2 is able to withstand robust use. In addition, the various parts of the apparatus 2 are able to be manufactured and to be connected together in a commercially economical manner. Thus the entire apparatus 2 becomes a commercially viable item because it can be manufactured in a cost-effective manner and therefore sold at a cost-effective price, and because the apparatus 2 can also be manufactured such that it looks nice and it is reliable in use.

Referring now to FIG. 8, there is shown apparatus 48 for use by a person for dissipating an electrostatic charge. The apparatus 48 is in the form of a sphere, as compared to the apparatus 2 being in the general form of a tube. For ease of comparison and understanding, similar parts in the apparatus 2 and 48 have been given the same reference numerals. The various parts in the apparatus 48 may be manufactured and connected similarly to the apparatus 2. The apparatus 48 shown in FIG. 8 is to illustrate how the apparatus of the present invention can be formed in different desired aesthetically pleasing shapes. In FIG. 1, it will be seen that the contact portion 6 has a ball 50 for contacting the object 8. In FIG. 8, the contact portion 6 forms part of an overall sphere with the body portion 4 and the intermediate portion 10.

It is to be appreciated that the embodiments of the invention described above with reference to the accompanying drawings have been given by way of example only and that modifications may be effected. Thus, for example, attachment means other than the hole 40 may be employed. The apparatus may have shapes other than those shown in the drawings. The intermediate portion may be provided with a covering of an electrically insulating material. This covering may provide a soft texture look and feel, and it may also provide a water-proof connection between the intermediate portion 10 and the body portion 4 on the one hand, and between the intermediate portion 10 and the contact portion 6 on the other hand. In FIG. 1, the metal object 8 is shown as a door catch of a motor vehicle but any appropriate object may be used. The contact portion 6, for example, may be provided with a covering of an electrically conducting material that helps to prevent damage such as scratching to objects contacted by the contact portion. The covering may be made of electrically conducting rubber or an electrically conducting plastics material.

1. Apparatus for use by a person for dissipating an electrostatic charge, which apparatus comprises a body portion for being held in the person's hand, a contact portion for contacting an object in order to dissipate the electrostatic charge, and an intermediate portion positioned between the body portion and the contact portion, and the apparatus being such that the body portion is made of an electrically conducting material, the contact portion is made of an electrically conducting material, the intermediate portion is made of an electrically insulating material, the body portion has a recess, the contact portion has a recess, the intermediate portion has a first part which extends into the recess in the body portion and which is secured to the body portion by first securing means, the intermediate portion has a second part which extends into the recess in the contact portion and which is secured to the contact portion by a second securing means, a resistor is mounted on the intermediate portion, a first leaf spring is mounted on the first part of the intermediate portion such that the first leaf spring causes electrical contact between a first lead from the resistor and the interior of the body portion, and a second leaf spring is mounted in the recess in the contact portion such that the second leaf spring causes electrical contact between a second lead from the resistor and the interior of the contact portion, whereby the first securing means is a single screw located in a bore extending from an end of the body portion remote from the contact portion and the second securing means is a pair of screws extending through the second part of the intermediate portion and into the contact portion such that the compression of the second leaf spring provides both secure electrical contact and a constant upward force thereby preventing the loosening of the pair of screws located between the intermediate portion and the contact portion.

2. Apparatus according to claim 1 in which the pair of screws extend one each through a pair of wing members on the second part of the intermediate portion.

3. Apparatus according to claim 1 in which the body portion includes attachment means for attaching a key holder to the body portion.

4. Apparatus according to claim 3 in which the attachment means is a hole through which the key holder is passed.

5. Apparatus according to claim 3 and including the key holder.

6. Apparatus according to claim 5 in which the key holder is a key ring.

7. Apparatus according to claim 1 in which the body portion is made of a metal alloy.

8. Apparatus according to claim 7 in which the metal alloy is finished with matt nickel.

9. Apparatus according to claim 1 in which the contact portion is made of a metal alloy.

10. Apparatus according to claim 9 in which the metal alloy is finished with shiny nickel.

11. Apparatus according to claim 1 in which the contact portion has a covering of an electrically conducting material that is such that it will not damage objects contacted by the contact portion.

12. Apparatus according to claim 1 in which the intermediate portion is made of acrylonitrile butadiene styrene.

13. Apparatus according to claim 1 in which the intermediate portion is provided with a covering of an electrically insulating material.

14. Apparatus according to claim 13 in which the covering of the electrically insulating material provides a water-proof connection between the intermediate portion and the body portion, and between the intermediate portion and the contact portion.

15. Apparatus according to claim 1 and which is generally tubular in shape.
